(19) United States
(12) Patent Application Publication
(10) Pub. No.: US 2026/0339791 A1
(43) Pub. Date: Oct. 29, 2026

(54) Correcting analytics data from a database

(71) Applicant: OWN DATA COMPANY LTD., Tel Aviv (IL)

(72) Inventor: Adrian Edward Kunzle, New York, NY (US)

(21) Appl. No.: 19/190,650

(22) Filed: Apr. 27, 2025

(51) Int. Cl. G06F 11/1446

(52) U.S. Cl. CPC G06F 11/1469

(57) ABSTRACT

A system for use with a database that stores data includes a storage device, configured to store a time series of the data, and a processor. The processor is configured to identify a restore job specifying a correction to a corruption in the data and a backup of the database made prior to the corruption, from which the correction is derived, to identify, based on a timestamp of the backup, a start time from which to apply the correction to the time series, and to apply the correction, from the start time, to the time series. Other embodiments are also described.

### FIELD OF EMBODIMENTS OF THE DISCLOSURE

The present disclosure relates generally to databases, and particularly to managing data retrieved from a database.

### BACKGROUND

Databases are structured collections of data that are stored and accessed electronically. They are managed by database management systems, which provide an interface for users and application programs to interact with the data. Databases ensure that data is consistently organized and easily accessible, allowing for efficient data retrieval, manipulation, and management. They are essential in various applications, from business operations to scientific research, enabling the storage and processing of large volumes of information.

### BRIEF DESCRIPTION OF THE DRAWINGS

FIG. 1 is a block diagram of a system for maintaining historical data for analysis, in accordance with some embodiments of the present disclosure;

FIG. 2 is a block diagram showing an example of a table image storing data downloaded from a data table, in accordance with some embodiments of the present disclosure;

FIG. 3 is a block diagram that schematically illustrates an example of an archive directory structure for archived table images, in accordance with an embodiment of the present disclosure;

FIG. 4 is a block diagram that schematically illustrates an example of a database directory structure that can be used to store a partitioned database, in accordance with some embodiments of the present disclosure;

FIG. 5 is a schematic illustration of a method for correcting historical data from a database, in accordance with some embodiments of the present disclosure; and

FIG. 6 is a flow diagram for a method for correcting historical data from a database, in accordance with some embodiments of the present disclosure.

### DETAILED DESCRIPTION

### Overview

In some systems, a data server manages a database, and a data analysis server creates and maintains at least one time series of historical data from the database. A challenge, in such systems, is that some of the data in the database may be corrupted, such that even if the corruption is identified and corrected on the data server, the historical time series will continue to contain corrupt data.

To address this challenge, in some embodiments of the present disclosure, the data analysis server identifies the restore jobs in which any corrections to the data are defined, and applies the corrections to the historical data. Typically, the restore jobs are created on, and executed by, a backup server that backs up the database, and the data analysis server obtains the restore jobs from the backup server, e.g., by querying the backup server.

### System Description

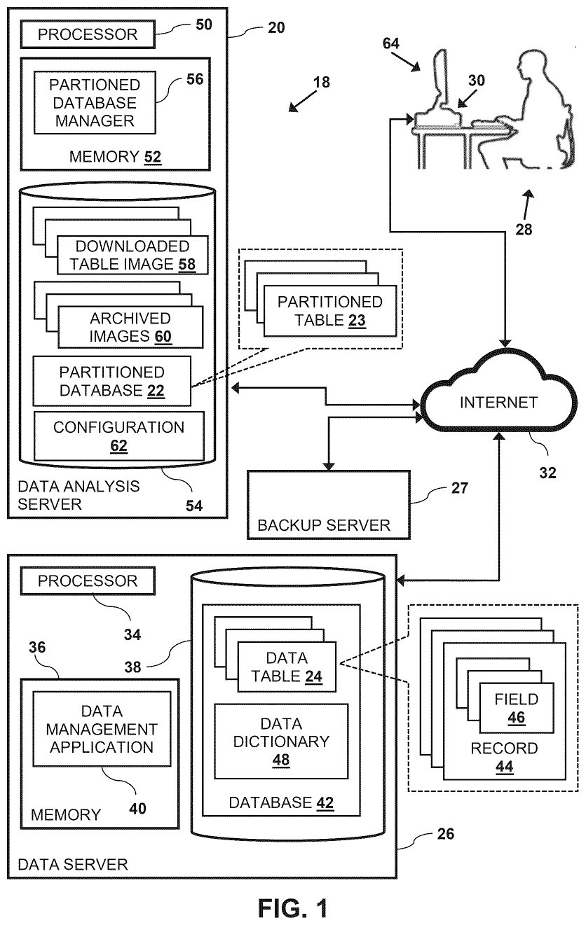

Reference is initially made to FIG. 1, which is a block diagram of a system 18 for maintaining historical data for analysis, in accordance with some embodiments of the present disclosure.

System 18 comprises a data server 26, which comprises a server processor 34, a server memory 36, and a server storage device 38. In some embodiments, memory 36 stores a data management application 40 that processor 34 executes to manage a database 42 comprising data tables 24 stored on storage device 38. In the configuration shown in FIG. 1, each data table 24 comprises a set of data records 44, each of which stores data in multiple data fields 46. In embodiments of the present disclosure, database 42 may store any type of data using any suitable structure.

In a first example, data management application 40 comprises a database management system such as a structured query language (SQL) server (e.g., MICROSOFT SQL SERVER™, produced by Microsoft Corporation, One Microsoft Way Redmond, WA 98052-6399 USA), and data records 44 comprise database tables.

In a second example, data management application 40 comprises a customer relationship management (CRM) system such as SALESFORCE™ (produced by Salesforce, Inc., Salesforce Tower 3rd Floor, 415 Mission Street, San Francisco, CA 94105 USA) and data records 44 comprise CRM data files such as standard or custom SALESFORCE™ objects.

In a third example, data management application 40 comprises a customer service system such as ZENDESK™ (produced by Zendesk Inc., 1019 Market Street, San Francisco, CA 94103 USA), and data records 44 store customer service system ticket data files.

In a fourth example, data management application 40 comprises an enterprise resource planning (ERP) system such as NETSUITE™ (produced by Oracle Corporation, 500 Oracle Parkway, Redwood City, CA 94065 USA), and data records 44 store ERP data files.

In a fifth example, data management application 40 comprises an accounting system such as SAGE BUSINESS CLOUD ACCOUNTING™ (produced by The Sage Group plc, North Park, Newcastle upon Tyne NE13 9AA, United Kingdom), and data records 44 stores accounting data files.

In a sixth example, data management application 40 comprises a messaging application such as SLACK™ (produces by Slack Technologies, Inc., 500 Howard Street, San Francisco, CA 94105 USA), and data records 44 store messaging system data files.

In a seventh example, data management application 40 comprises a project management application such as JIRA™ (produced by Atlassian Corporation Plc, 341 George Street, Level 6, Sydney, NSW 2000, Australia), and data records 44 store project management data files.

In addition to these examples, any other type of application 40 that is configured to manage information stored in data records 44 is considered to be within the spirit and scope of the present disclosure.

In some embodiments, storage device 38 stores a data dictionary 48 that defines the layout and configuration of data fields 46 in data records 44.

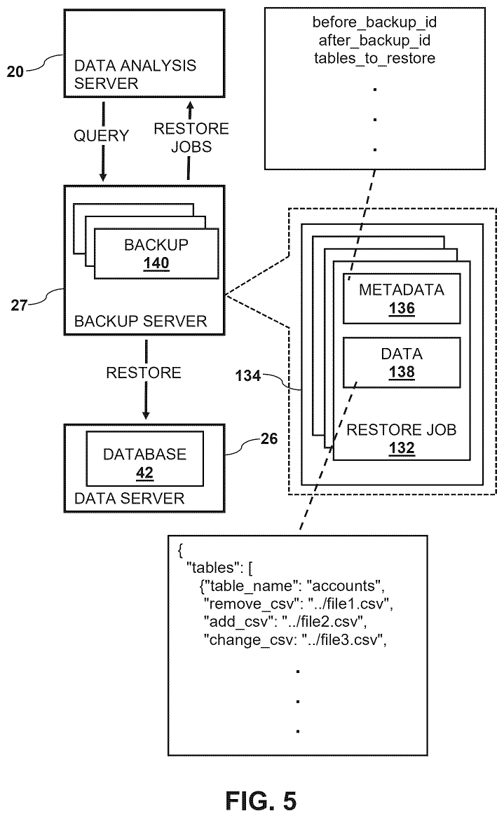

Typically, system 18 further comprises a backup server 27, which also comprises a processor, memory, and storage device (not shown). Data tables 24 are backed up to backup server 27 (e.g., periodically at predefined intervals), and the backup copies are stored on the storage device of the backup server, as shown in FIG. 5, which is described below.

System 18 further comprises a data analysis server 20, which comprises an analysis processor 50, an analysis memory 52, and an analysis storage device 54. By executing suitable software loaded into memory 52, processor 50 maintains, and processes queries for, at least one time series of data from database 42. Typically, the data is downloaded, by processor 50, from backup server 27. Alternatively, the data is downloaded from data server 26. The queries can be submitted, for example, by a user 28 operating a client computer 30, which comprises a display 64 for displaying query results.

In some embodiments, the downloaded data is stored in a partitioned database 22 comprising a set of partitioned database tables 23. Processor 50 executes, from memory 52, a partitioned database manager 56 that maintains partitioned database 22 and processes queries for data stored in the partitioned database.

In the configuration shown in FIG. 1, data server 26 and backup server 27 exchange communication over a public network 32, such as the Internet. Likewise, data analysis server 20 communicates with data server 26, backup server 27, and/or client computer 30 over network 32. In some embodiments, data analysis server 20 uses a secure communication protocol to protect data transmitted over network 32.

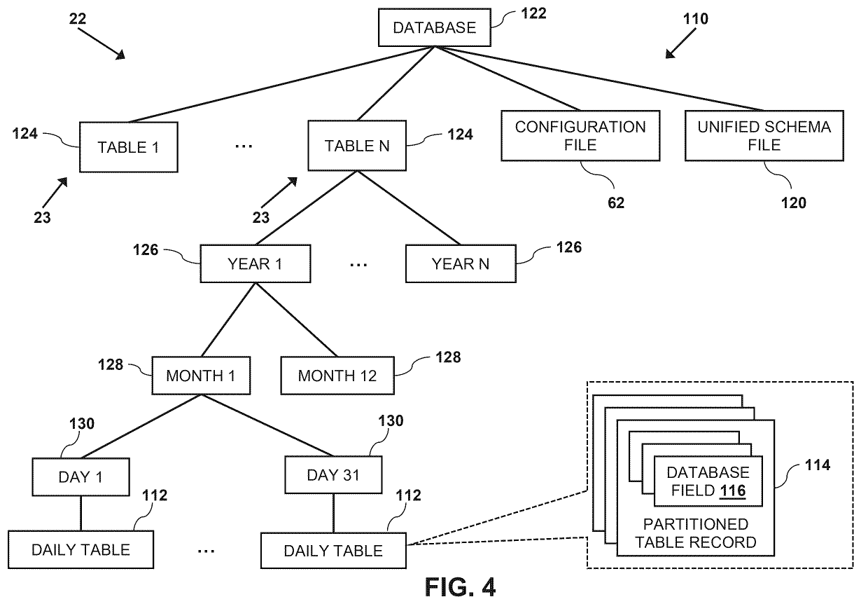

In the configuration shown in FIG. 1, partitioned database manager 56 manages the following data entities stored on storage device 54:
Partitioned database 22. Partitioned database 22 is described with reference to FIG. 4 below.
A set of downloaded table images 58. In embodiments described herein, partitioned database manager 56 retrieves—typically, from backup server 27—data from one or more data tables 24, and stores the retrieved data to downloaded table images 58. In some embodiments, the data is retrieved at predefined intervals (e.g., daily). In other embodiments, data from a data table 24 is retrieved only upon a change being made to the table (i.e., upon a data record 44 being added to or deleted from the table, or upon an update to a data record.

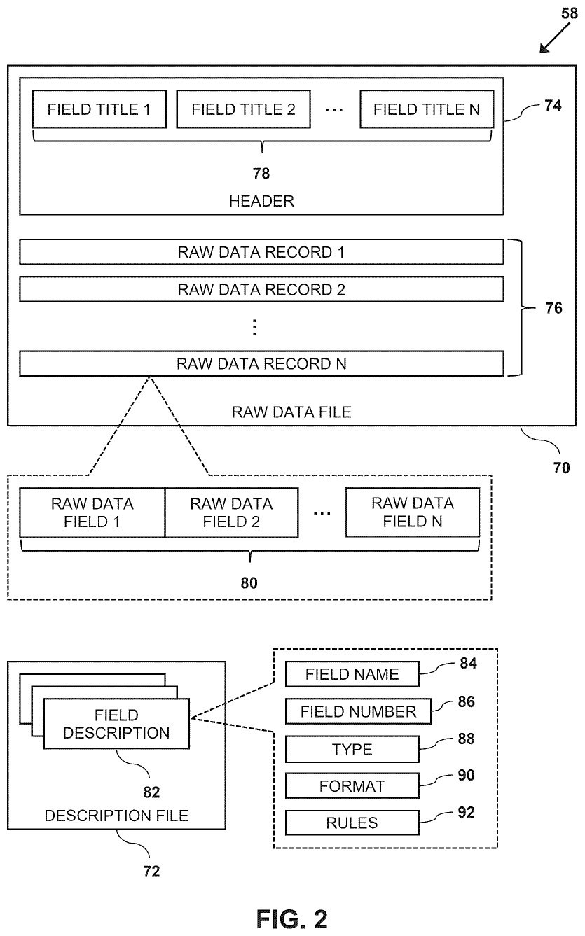

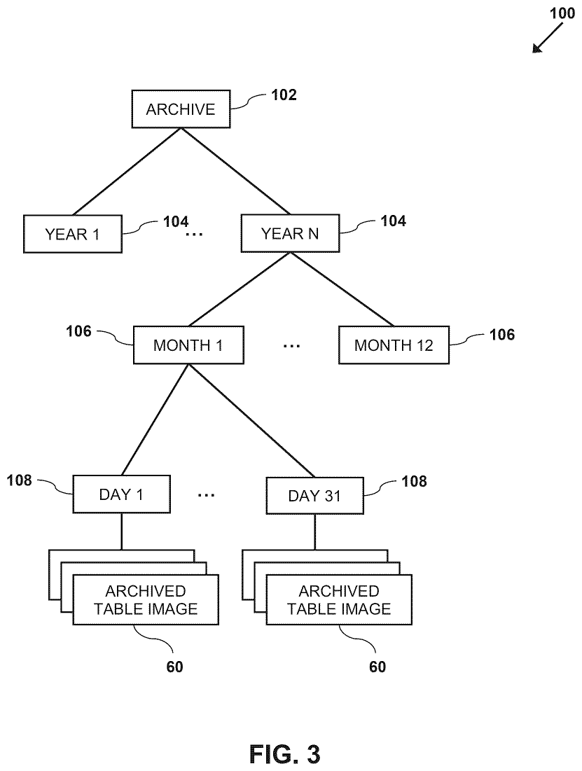

Downloaded table images 58 are described in the description referencing FIG. 2 hereinbelow.
A set of archived table images 60. In embodiments described herein, upon downloading data from data tables 24 and populating the set of downloaded table images 58, partitioned database manager 56 archives the set of downloaded table images 58, as described in the description referencing FIG. 3 hereinbelow. Archived table images 60 are used to create partitioned database 22, as described in the description referencing FIG. 4 hereinbelow.
A configuration file 62. In embodiments described herein, configuration file 62 stores information as to which data fields 46 are to be included in partitioned database 22, as further described below with reference to FIG. 4. In addition, for each time series, configuration file 62 stores the start time of the time series and, provided the time series is not to be continually updated, the end time of the time series.

In some embodiments, the tasks performed by partitioned database manager 56 are split among multiple physical and/or virtual computing devices. In other embodiments, the tasks performed by data management application 40 and/or partitioned database manager 56 are performed in a data cloud.

Examples of memories 36, 52 include dynamic random-access memories and non-volatile random-access memories. Examples of storage devices 38, 54 include hard disk drives and solid-state disk drives.

In general, each of the processors described herein may be embodied as a single processor, or as a cooperatively networked or clustered set of processors. The functionality of the processor may be implemented solely in hardware, e.g., using one or more fixed-function or general-purpose integrated circuits, Application-Specific Integrated Circuits (ASICs), and/or Field-Programmable Gate Arrays (FPGAs). Alternatively, this functionality may be implemented at least partly in software. For example, the processor may be embodied as a programmed processor comprising, for example, a central processing unit (CPU) and/or a Graphics Processing Unit (GPU). Program instructions, including software programs, and/or data may be loaded for execution and processing by the CPU and/or GPU. The program instructions and/or data may be downloaded to the processor in electronic form, over a network, for example. Alternatively or additionally, the program instructions and/or data may be provided and/or stored on non-transitory tangible media, such as magnetic, optical, or electronic memory. Such program instructions and/or data, when provided to the processor, produce a machine or special-purpose computer, configured to perform the tasks described herein.

Reference is now additionally made to FIG. 2, which is a block diagram showing an example of a table image 58 storing data downloaded from a data table 24, in accordance with some embodiments of the present disclosure.

Typically, each table image 58 comprises a raw data file 70 comprising a header 74 and a set of raw data records 76, which represent data in corresponding data records 44. Header 74 comprises a set of field titles 78, which are the titles of the data fields 46 in the data records 44 downloaded from the data table. Each raw data record 76 comprises a set of raw data fields 80 that have a one-to-one correspondence with field titles 78. In some embodiments, instead of the tabular structure depicted in FIG. 2, raw data file 70 has a self-describing structure, whereby field titles 78 are repeated as a structure around each raw data record 76. For example, in some embodiments, raw data file 70 is composed in JavaScript™ Object Notation (JSON) or Extensible Markup language (XML).

In some embodiments, raw data file 70 stores data from all the fields in its corresponding data table 24, such that the number of raw data fields 80 (and of field titles 78) equals the number of data fields 46. In other embodiments, raw data file 70 stores data from only some of the fields in its corresponding data table 24, such that the number of raw data fields 80 (and of field titles 78) is less than the number of data fields 46.

In some embodiments, for each raw data field 80, table image 58 includes a copy of the data stored in the corresponding data table 24. In other embodiments, table image 58 includes only deltas (i.e., additions, deletions, and changes) from the most recent archived table image 60.

Typically, partitioned database manager 56 stores raw data file 70 in a standard format used for data exchange. For example, in some embodiments, file 70 comprises a comma separated value (CSV) file.

Typically, each table image 58 further comprises a description file 72 comprising a set of field descriptions 82 that describe the data fields 46 in the downloaded data records 44, and thus have a one-to-one correspondence with raw data fields 80 (and with field titles 78). Each field description 82 can store information such as:
A field name 84. This can be the same as the corresponding field title 78.
A field number 86. Since CSV files do not store fields at fixed locations, field number 86 can be used to locate a raw data field 80 in any given raw data record 76. For example, since values in CSV files are separated by commas (or other delimiters), field number 86 can be the number of commas before or after the field.
A field type 88. Examples of field type 88 include date, numeric and text.
A field format 90. In one example, the field format for numeric data indicates a number of digits to the right of the decimal point. In another example, the field format can describe formats for telephone numbers, postal (e.g., ZIP) codes, or email addresses.
One or more field rules 92. A given rule 92 can indicate a list of valid text/numeric data for a given raw data field 80, or minimum/maximum values for numeric data.

As described above, downloaded table images 58 are archived to archived table images 60. In this regard, reference is now additionally made to FIG. 3, which is a block diagram that schematically illustrates an example of an archive directory structure 100 for archived table images 60, in accordance with an embodiment of the present disclosure.

In the example shown in FIG. 3, processor 50 creates archive directory structure 100 on storage device 54 as follows:
Create an archive directory 102.
Create year directories 104, which are subdirectories of directory 102, for each year during which the partitioned database manager downloads table images 58.
Create month directories 106, which are subdirectories of each year directory 104, for each month during which the partitioned database manager downloads table images 58.
Create day directories 108, which are subdirectories of each month directory 106, for each day that the partitioned database manager downloads table images 58.

Each downloaded table image 58 is then stored to the day directory 108 corresponding to the date on which the table image was downloaded (and to the day directories of any subsequent days during which the table remained unchanged), thereby becoming an archived table image 60. In some embodiments, multiple table images 58 for the same table are captured at different respective points in time during the same day (e.g., in response to changes in the table or periodically, such as every 4, 6 or 8 hours, irrespective of any changes), and are stored together to the same day directory 108 or to different respective subdirectories thereof.

As described above, in some embodiments, archived table images 60 are used to create partitioned database 22. For example, for embodiments in which archived table images 60 are stored as CSV files, processor 50, by executing partitioned database manager 56, loads the data from the CSV files into partitioned database 22.

In this regard, reference is now additionally made to FIG. 4, which is a block diagram that schematically illustrates an example of a database directory structure 110 that processor 50 can use to store partitioned database 22 on storage device 54, in accordance with some embodiments of the present disclosure.

As described supra, partitioned database 22 comprises a set of partitioned tables 23. Each partitioned table 23 comprises multiple partitioned daily database tables 112, each of which comprises a set of partitioned table records 114 comprising respective partitioned database fields 116. Each daily table 112 is created from a respective archived table image 60, in that the data from the archived table image is loaded to the daily table.

In some embodiments, partitioned database manager 56 defines each partitioned table 23 as a logical database table comprising a set of physical daily tables 112.

In some embodiments, partitioned database manager 56 creates daily tables 112 based on configuration file 62, which indicates, for each table, which fields from the archived table image to include in daily table 112, as well as the dates for which the daily tables should be created. Alternatively or additionally, partitioned database manager 56 replies to queries to partitioned database 22 based on a unified schema file 120, which tracks changes to the schema of each table, such as added or deleted fields, or changes to the data type of a field.

In some embodiments, processor 50 creates database directory structure 110 on storage device 54 as follows:
Create a database directory 122.
Store configuration file 62 and unified schema file 120 to database directory 122.
Create, for each partitioned table 23, a corresponding table directory 124 as a subdirectory of directory 122.
For each table directory 124, create, as needed, year directories 126 as subdirectories of the table directory, for each year during which partitioned database manager 56 created archived table images 60 for the table.
For each year directory 126, create, as needed, month directories 128 as subdirectories of the year directory, for each month (of the year referenced by the year directory) during which partitioned database manager 56 created archived table images 60 for the table.
For each month directory 128, create, as needed, day directories 130 as subdirectories of the month directory, for each day (in the month referenced by the month directory) during which partitioned database manager 56 created archived table images 60 for the table.

For some embodiments in which multiple table images 58 of the same table are captured daily—and hence, multiple archived table images 60 of the table are stored for the same day—partitioned database manager 56 creates multiple tables in lieu of a single daily table 112.

In the example shown in FIG. 4, directory structure 110 is an inversion of directory structure 100 of FIG. 3, whereby the division by date comes after the division by table. In other embodiments, directory structure 110 is similar to directory structure 100, such that multiple daily tables 112 (for different respective tables) are stored in the same day directory 130.

### Applying Corrections

Reference is now additionally made to FIG. 5, which is a schematic illustration of a method for correcting historical data from database 42 (FIG. 1), in accordance with some embodiments of the present disclosure.

In some cases, data in database 42 may become corrupted. Such a corruption may include, for example, a deletion of some of the data, an addition of incorrect data, or an incorrect modification of some of the data. In such cases, provided the corruption is identified, a restore job 132, which specifies a correction to the corruption, is defined. Following the definition of restore job 132, the restore job is executed, such that the correction to database 42 is made.

For example, in some embodiments, a user of backup server 27, which backs up database 42 by storing multiple backups 140 of the database, defines restore job 132. Subsequently, backup server 27 executes the restore job, thereby making the required correction. Typically, the backup server also adds the restore job to a job list 134 stored on the backup server.

Typically, in such embodiments, the correction is derived from a backup 140 that was made prior to the corruption, i.e., the correction is defined so as to revert the corrupted portion of the data to its pre-corruption state in this backup. In some such embodiments, the restore job specifies the pre-corruption backup 140 from which the correction is derived.

As a specific example, in some embodiments, the user creates restore job 132 by comparing a backup 140 in which one or more tables are corrupt with an earlier backup 140 that was made prior to the corruption. After comparing the two tables, backup server 27 presents a list of the differences between the tables (including created, modified, and/or deleted records) to the user. The user selects the unwanted differences and then creates restore job 132 to revert those differences. (Typically, the user minimizes the time between the two tables, i.e., the user selects the latest known pre-corruption backup and/or the earliest known corrupt backup, so as to minimize the total number of differences between the tables.) In some such embodiments, the restore job specifies, in addition to the pre-corruption backup 140, the corrupt backup to which the pre-corruption backup was compared.

In some embodiments, restore job 132 includes metadata 136, which includes high-level job parameters. For example, in some embodiments, metadata 136 includes a field (named “tables_to_restore” in FIG. 5) that references any data tables 24 in database 42 to which the restore job applies (i.e., any data tables that were corrupted and are therefore in need of correction). Alternatively or additionally, for some embodiments in which restore job 132 is created from backups 140 as described above, metadata 136 includes a field (named “before_backup_id” in FIG. 5) that references the pre-corruption backup 140 and another field (named “after_backup_id” in FIG. 5) that references the corrupt backup.

Alternatively or additionally, restore job 132 includes restore data 138, which includes lower-level job parameters. For example, in some embodiments, for each table 24 to which the restore job applies, restore data 138 includes the information needed to correct the data in the table. For example, in addition to identifying the table (e.g., by the name of the table), restore data 138 may include, for each type of correction that is to be made to the table, the path of a file, such as a CSV file, in which the correction of that type is specified. By way of example, FIG. 5 shows, for the “accounts” table, three file paths:
a remove_csv file path, which references a file including the identifiers of any data records 44 that are to be removed from the table;
an add_csv file path, which references a file including one or more data records 44 that are to be added to the table; and
a change_csv file path, which references a file including the identifiers of any data records 44 that are to be changed, along with the corrected values of data fields 46 in each of these data records.

In some embodiments, as shown in FIG. 5, restore data 138 is specified in JavaScript™ Object Notation (JSON).

Processor 50 of data analysis server 20 is configured to identify each restore job 132. Processor 50 is further configured to identify, from the restore job, a time, referred to herein as a “start time,” from which to apply the correction to a time series of data from database 42. The processor is further configured to apply the correction specified by the restore job, from the start time, to the time series. In other words, for each time in the time series beginning with the start time, the processor corrects the data, per the restore job, if the data is corrupt.

For example, in some embodiments, the processor applies the correction to partitioned tables 23, e.g., by applying the correction to each corrupt daily table 112. Alternatively, the processor applies the correction to archived images 60, and then generates (or regenerates) partitioned tables 23 from the corrected archived images.

In some cases, the processor applies the correction upon creating the time series. For example, in some embodiments, immediately after creating partitioned tables 23 from archived images 60 for any one or more data tables, the processor iterates through any restore jobs pertaining to the tables and to the time span covered by the partitioned tables, and applies the corrections specified by these jobs to the partitioned tables. Alternatively, the processor can apply the correction to the time series at any other time.

In the context of the present application, including the claims, a “time” in a time series can refer to a date, a time of day, or a combination of a date with a time of day (e.g., Feb. 11, 2025 at 15:34). For example, supposing that a partitioned table 23 includes a single daily table 112 per day, the start time identified by the processor is the earliest date at which the correction may be required. On the other hand, if the partitioned table includes multiple tables per day, the start time may be the earliest date and time-of-day at which the correction may be required.

Typically, for embodiments in which restore job 132 specifies (e.g., in the before_backup_id field described above) the pre-corruption backup from which the correction is derived, the processor identifies the start time for the correction based on the timestamp of this backup. For example, in some embodiments, the processor identifies, as the start time, the time that immediately follows this timestamp in the time series. For example, assuming a single daily table 112 for each day in the time series, if the pre-corruption backup has a timestamp of Jan. 1, 2025, the processor may identify Jan. 2, 2025 as the start time for the correction.

Typically, the processor identifies each restore job 132 by obtaining the restore job from backup server 27.

Typically, the processor obtains each restore job from backup server 27 by querying the backup server for restore jobs. For example, in some embodiments, the processor queries the backup server for job list 134 or a portion thereof, such as any restore jobs added to the job list after a particular time, such as the time of the most recent previous query. In response to the query, backup server 27 returns the requested restore jobs.

For example, in some embodiments, the processor queries backup server 27 for restore jobs 132 upon querying the backup server for data to add to the time series, e.g., upon querying the backup server for any new table image 58. Alternatively or additionally, the processor queries the backup server for restore jobs upon creating a time series, e.g., immediately prior to or subsequently to creating the time series. Alternatively or additionally, the processor periodically queries the backup server for restore jobs.

In other embodiments, backup server 27 is configured to forward each restore job to data analysis server 20 upon the creation of the job, such that the processor obtains the restore job by virtue of the forwarding.

Typically, the processor stores each obtained restore job. Subsequently, upon the creation of a time series, the processor iterates through the stored restore jobs, and applies any required corrections specified by the restore jobs to the new time series.

In some embodiments, to perform the correction functionality described above, the processor executes partitioned database manager 56.

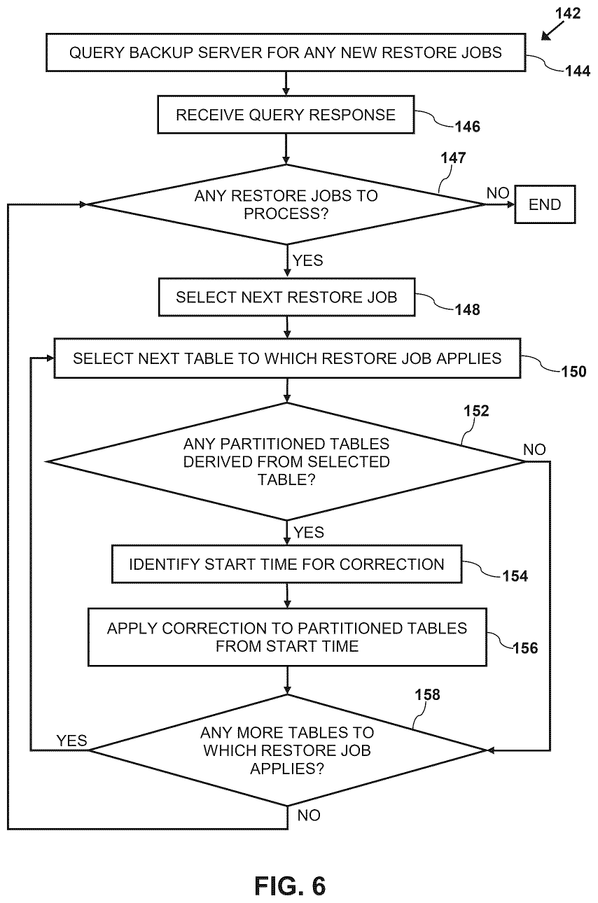

Reference is now made to FIG. 6, which is a flow diagram for a method 142 for correcting historical data from a database, in accordance with some embodiments of the present disclosure.

Method 142 begins with a querying step 144, at which the processor of the data analysis server queries the backup server for any new restore jobs, i.e., any restore jobs created after the most recent previous query. Subsequently to sending the query to the backup server, the processor receives a response to the query at a response-receiving step 146. The processor then checks, at a checking step 147, whether the query response includes any restore jobs to be processed. If not, method 142 ends. Otherwise, the processor selects one of the restore jobs at a job-selecting step 148.

After selecting each restore job, the processor, at a table-selecting step 150, selects a table to which the restore job applies (i.e., a table designated for correction by the restore job). For example, with reference to the example in FIG. 5, the processor may select the “accounts” table referenced by the “table_name” field in restore data 138. After selecting the table, the processor checks, at a checking step 152, whether any partitioned tables 23 (FIG. 1) are derived from the selected table, i.e., whether any partitioned tables were constructed from archived images 60 (FIG. 1) of the selected table. If yes, the processor, at a start-time-identifying step 154, identifies the start time for the correction, e.g., based on the specification, in metadata 136, of the pre-corruption backup, as described above with reference to FIG. 5. Next, at a correcting step 156, the processor applies the correction to the partitioned tables from the start time. Subsequently, or if no partitioned tables are derived from the selected table, the processor checks, at a checking step 158, whether any more tables remain to be selected. If yes, the processor returns to table-selecting step 150. Otherwise, the processor returns to checking step 147.

There is therefore provided, in accordance with some embodiments of the present invention, a system for use with a database that stores data. The system includes a storage device, configured to store a time series of the data, and a processor. The processor is configured to identify a restore job specifying a correction to a corruption in the data, to identify, from the restore job, a start time from which to apply the correction to the time series, and to apply the correction, from the start time, to the time series.

There is further provided, in accordance with some embodiments of the present invention, a method for use with a database that stores data. The method includes identifying, by a processor, a restore job specifying a correction to a corruption in the data, identifying, from the restore job, a start time from which to apply the correction to a time series of the data, and applying the correction, from the start time, to the time series.

In some embodiments, the time series includes one or more partitioned tables in a partitioned database, and applying the correction includes applying the correction to the partitioned tables.

In some embodiments, the time series includes multiple archived table images, and applying the correction includes applying the correction to the archived table images.

In some embodiments, the restore job specifies a backup of the database made prior to the corruption, from which the correction is derived, and identifying the start time includes identifying the start time based on a timestamp of the backup.

In some embodiments, the restore job is stored on a backup server that backs up the database, and identifying the restore job includes identifying the restore job by obtaining the restore job from the backup server.

In some embodiments, obtaining the restore job from the backup server includes obtaining the restore job by querying the backup server for restore jobs.

In some embodiments, querying the backup server for restore jobs includes periodically querying the backup server for restore jobs.

In some embodiments, querying the backup server for restore jobs includes querying the backup server for restore jobs upon querying the backup server for some of the data to add to the time series.

In some embodiments, querying the backup server for restore jobs includes querying the backup server for restore jobs upon creating the time series.

There is further provided, in accordance with some embodiments of the present invention, a computer software product for use with a database that stores data, the product including a tangible non-transitory computer-readable medium in which program instructions are stored. The instructions, when read by a processor, cause the processor to identify a restore job specifying a correction to a corruption in the data, to identify, from the restore job, a start time from which to apply the correction to a time series of the data, and to apply the correction, from the start time, to the time series.

It will be appreciated by persons skilled in the art that the present disclosure is not limited to what has been particularly shown and described hereinabove. Rather, the scope of the present disclosure includes both combinations and subcombinations of the various features described hereinabove, as well as variations and modifications thereof that are not in the prior art, which would occur to persons skilled in the art upon reading the foregoing description.

1. A system for use with a database that stores data, the system comprising:
a storage device, configured to store a time series of the data; and
a processor, configured to:
identify a restore job specifying:
a correction to a corruption in the data including a deletion of some of the data, an addition of incorrect data, or an incorrect modification of some of the data, and
a backup of the database made prior to the corruption, from which backup the correction is derived,
identify, based on a timestamp of the backup, a start time from which to apply the correction to the time series, and
apply the correction, from the start time, to the time series.

2. The system according to claim 1, wherein the time series includes one or more partitioned tables in a partitioned database, and wherein the processor is configured to apply the correction to the partitioned tables.

3. The system according to claim 1, wherein the time series includes multiple archived table images, and wherein the processor is configured to apply the correction to the archived table images.

4. The system according to claim 1, wherein the restore job is stored on a backup server that backs up the database, and wherein the processor is configured to identify the restore job by obtaining the restore job from the backup server.

5. A method for use with a database that stores data, the method comprising:
identifying, by a processor, a restore job specifying:
a correction to a corruption in the data including a deletion of some of the data, an addition of incorrect data, or an incorrect modification of some of the data, and
a backup of the database made prior to the corruption, from which backup the correction is derived;
identifying, based on a timestamp of the backup, a start time from which to apply the correction to a time series of the data; and
applying the correction, from the start time, to the time series.

6. The method according to claim 5, wherein the time series includes one or more partitioned tables in a partitioned database, and wherein applying the correction comprises applying the correction to the partitioned tables.

7. The method according to claim 5, wherein the time series includes multiple archived table images, and wherein applying the correction comprises applying the correction to the archived table images.

8. The method according to claim 5, wherein the restore job is stored on a backup server that backs up the database, and wherein identifying the restore job comprises identifying the restore job by obtaining the restore job from the backup server.

9. The method according to claim 8, wherein obtaining the restore job from the backup server comprises obtaining the restore job by querying the backup server for restore jobs.

10. The method according to claim 9, wherein querying the backup server for restore jobs comprises periodically querying the backup server for restore jobs.

11. The method according to claim 9, wherein querying the backup server for restore jobs comprises querying the backup server for restore jobs upon querying the backup server for some of the data to add to the time series.

12. The method according to claim 9, wherein querying the backup server for restore jobs comprises querying the backup server for restore jobs upon creating the time series.

13. A computer software product for use with a database that stores data, the product comprising a tangible non-transitory computer-readable medium in which program instructions are stored, which instructions, when read by a processor, cause the processor to:
identify a restore job specifying:
a correction to a corruption in the data including a deletion of some of the data, an addition of incorrect data, or an incorrect modification of some of the data, and
a backup of the database made prior to the corruption, from which backup the correction is derived,
identify, based on a timestamp of the backup, a start time from which to apply the correction to a time series of the data, and
apply the correction, from the start time, to the time series.

14. The computer software product according to claim 13, wherein the time series includes one or more partitioned tables in a partitioned database, and wherein the instructions cause the processor to apply the correction to the partitioned tables.

15. The computer software product according to claim 13, wherein the time series includes multiple archived table images, and wherein the instructions cause the processor to apply the correction to the archived table images.

16. The computer software product according to claim 13, wherein the restore job is stored on a backup server that backs up the database, and wherein the instructions cause the processor to identify the restore job by obtaining the restore job from the backup server.

17. The computer software product according to claim 16, wherein the instructions cause the processor to obtain the restore job by querying the backup server for restore jobs.

18. The computer software product according to claim 17, wherein the instructions cause the processor to periodically query the backup server for restore jobs.

19. The computer software product according to claim 17, wherein the instructions cause the processor to query the backup server for restore jobs upon querying the backup server for some of the data to add to the time series.

20. The computer software product according to claim 17, wherein the instructions cause the processor to query the backup server for restore jobs upon creating the time series.
